(19) United States
(12) Patent Application Publication
(10) Pub. No.: US 2008/0313628 A1
(43) Pub. Date: Dec. 18, 2008

(54) METRICS PACK DISTRIBUTION FOR DATA REPORTING TOOL

(75) Inventors: Darren C. Justus, Seattle, WA (US); Neal R. Myerson, Seattle, WA (US); Carroll W. Moon, Altavista, VA (US); Susan K. Pallini, Windham, NH (US); Jitendra Luniya, Pune (IN)

Correspondence Address: LEE & HAYES PLLC, 421 W RIVERSIDE AVENUE SUITE 500, SPOKANE, WA, 99201, US

(73) Assignee: MICROSOFT CORPORATION, Redmond, WA (US)

(21) Appl. No.: 11/763,643

(22) Filed: Jun. 15, 2007

(51) Int. Cl. G06F 9/44

(52) U.S. Cl. 717/172; 717/168

(57) ABSTRACT

Systems and methods for implementing non-executable configuration files into a resource reporting application are disclosed. In accordance with one embodiment, a method for implementing non-executable configuration files into a resource reporting application includes developing one or more non-executable data files for implementation into the resource reporting application. The non-executable data files are then bundled into a file pack. The file pack is then distributed to the resource reporting application. The resource reporting application then implements one or more non-executable data files into the resource reporting application. In further embodiments, the non-executable data files include XML files. In some embodiments, the non-executable data files are bundled into a .cab file pack.

### BACKGROUND

Information technology (“IT”) professionals are increasingly being requested to demonstrate the health and performance of the IT Services they manage. For instance, an IT manager may be requested by company management to demonstrate the level of availability for the company's mail servers, file stores, world wide web (“WWW” or “web”) servers, gateway servers, application programs, or other computing resources. The level of availability for a computing resource refers to the time during each day, or other period of time, that the computing resource is operating and available for use.

The importance of being able to demonstrate the key performance indicators for IT services is becoming more important for a variety of reasons. For one, computing resources now more than ever are expected to be readily available to users. Accordingly, IT managers may be regularly asked to deliver ever higher levels of computing resource availability to meet company business requirements.

Another reason IT managers are being asked to demonstrate the level of availability for the systems they manage stems from the increased popularity of electronic mail (“e-mail”) and messaging service hosting providers. Service hosting providers own and manage the computing resources necessary to provide a computing service to users, such as e-mail, and charge users for the provision of the service. As the customers of hosting providers become more sophisticated, they are more commonly interested in having detailed information regarding the level of service they are receiving from their provider. This information may be used to set service level requirements in a service level agreement (“SLA”) between the hosting provider and the customer, and to determine whether the specified service levels are actually being met.

Accordingly, some IT professionals have turned to the use of resource reporting applications to provide metrics, that is, measurements for quantifying various performance aspects of computing resources. These resource reporting applications may enable IT professionals to understand the current health of computing resources. Additionally, the use of metrics may also assist IT professionals in making better decisions on resource deployment.

Specifically, the use of resource reporting applications may involve developing the proper set of metric definitions, deploying the metric definitions into the a resource reporting application, obtaining performance data on various computing resources, and analyzing and displaying the result based on the metric definitions.

Thus, it may be appreciated that the development and deployment of metric definitions are the fundamental steps of this entire process. However, in many instances, the deployment of metric definitions may be an arduous process that requires a significant investment in writing and implementing custom code. As a result, IT professionals may expend considerable resources to develop and deploy the proper set of metric definitions.

This process may be further complicated by the fact that once the set of metrics has been developed, it is often times difficult to build and deploy additional metrics into the resource reporting application. Often, the deployment of additional metrics means significant change to the base code and infrastructure used to develop and deploy the original metrics. For example, time consuming reinstallations of resource reporting applications are necessary to deploy the new metric definitions. This may result in extended downtimes during which computing resources cannot be monitored.

Thus, a solution that simplifies distribution and deployment of the pre-developed metrics to resource reporting applications may reduce or eliminate the resource burden associated with the addition of new metrics, as well as the resource burden stemming from the removal and modification of existing metrics.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Described herein are embodiments of various technologies for implementing non-executable configuration files into a resource reporting application. In one embodiment, an implementation includes developing one or more non-executable data files for implementation into the resource reporting application. The non-executable data files are then bundled into a file pack, which is distributed to the resource reporting application. A data import executable then implements one or more non-executable data files into the resource reporting application.

In a further embodiment, the one or more non-executable data files include Extensible Markup Language (XML) files. In some embodiments, the one or more non-executable data files are bundled into a .cab file pack. In other embodiments, the one or more non-executable data files include at least one of a metric calculation definitions file, a metric nesting definitions file, a database queries definitions file, and a metric target definitions file, a report form definitions file, and a metric display configuration definitions file.

In another embodiment, a computer readable medium for implementing non-executable configuration files into a resource reporting application includes computer-executable instructions. The computer executable instructions, when executed, perform a method that comprises receiving a file pack that includes one or more non-executable data files, unpacking the file pack into non-executable data files, and implementing the information in the non-executable data files into the metric reporting application.

In an additional embodiment, a system for implement non-executable configuration files into a resource reporting application comprises one or more processors. The system also comprises memory allocated for storing a plurality of computer-executable instructions that are executable by the one or more processors. The computer-executable instructions comprise instructions for receiving a file pack that includes one or more non-executable data files. The computer-executable instructions also comprise instructions for unpacking the file pack into one or more non-executable data files, as well as instructions for implementing information in the non-executable data files into a resource reporting application.

Other embodiments will become more apparent from the following detailed description when taken in conjunction with the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a simplified block diagram illustrating an exemplary data reporting environment. The environment includes an exemplary resource reporting application that may be updated by the “metric pack” distribution techniques and mechanisms described herein.

FIG. 2 is an illustrative metric report generated by the exemplary resource reporting application shown in FIG. 1.

FIG. 3 is a block diagram illustrating a “metric pack” distribution process implemented on the exemplary resource reporting application shown in FIG. 1.

FIG. 4 is an illustrative report form that may be generated by the exemplary resource reporting application based on information included in the “metric pack”.

FIG. 5 is a flow diagram showing an illustrative process for providing “metric pack” to the exemplary resource reporting application shown in FIG. 1.

FIG. 6 is a flow diagram showing an illustrative process for implementing the “metric pack” into the exemplary resource reporting application shown in FIG. 1.

FIG. 7 is a block diagram illustrating a representative computing environment. The representative environment may be a part of a computing device. Moreover, the representative computing environment may be used to implement the resource reporting application and the “metric pack” distribution techniques and mechanisms described herein.

### DETAILED DESCRIPTION

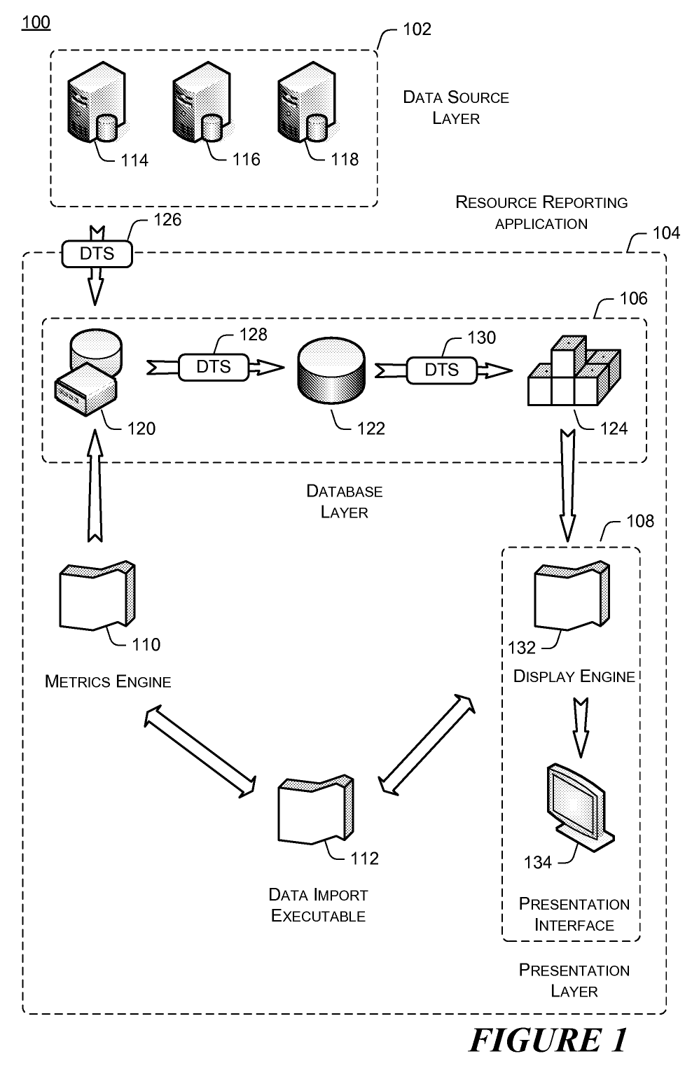

This disclosure is directed to a system that facilitates the modification of metric configurations in a resource reporting application by a “metric pack.” The “metric pack” may include data files that contain metric definitions, query definition information, and metric presentation information. The distribution of “metric packs” may advantageously enable IT operations and professionals to implement new metrics or update current metrics without expending considerable monetary and time resources. These resources may include efforts associated with writing custom code, implementing the code into the infrastructure platform, e.g., resource reporting application. For example, the deployment of metric data files onto a resource reporting application via a “metric pack” may enable the implementation of the metric configurations without the need to reinstall or reboot the resource reporting application. Likewise, the need to patch portions of the resource reporting application during deployment of the metric data files may also be eliminated. Various examples of distributing metric via a “metric pack” are described below with reference to FIGS. 1-7.

### Exemplary System Architecture

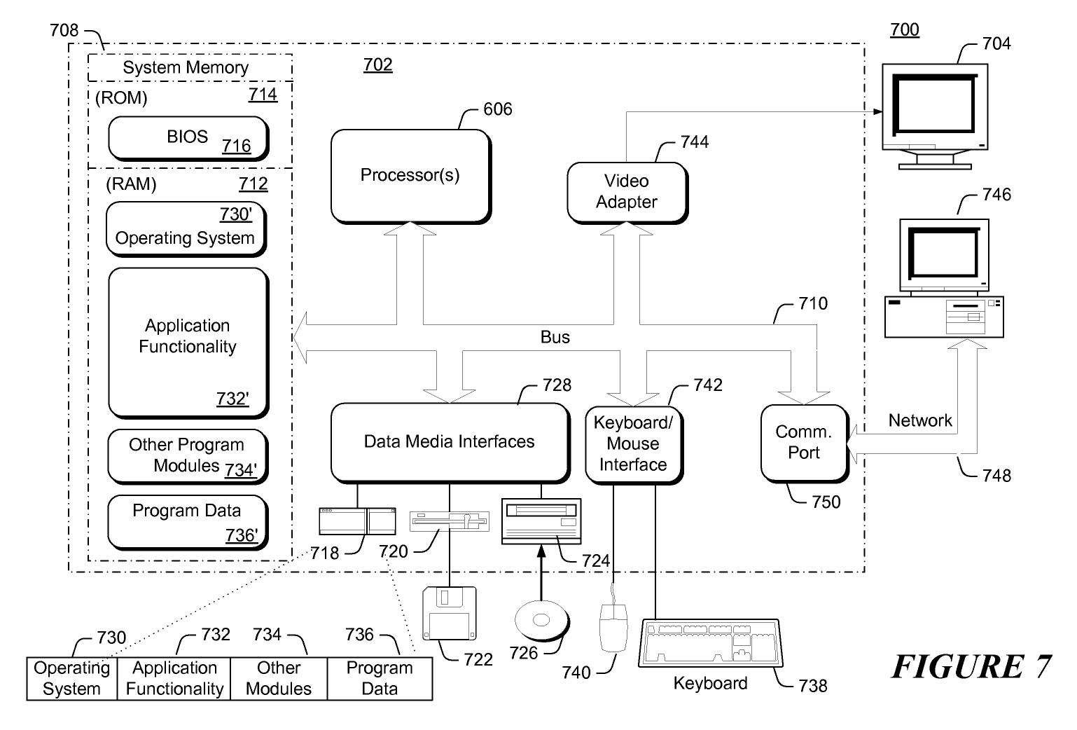

FIG. 1 illustrates an exemplary data reporting environment 100 that represents a system for collecting data regarding the availability of computing resources. A computing resource is any resource provide by one or more computing devices in a computing environment. For instance, a computing resource may include a mail server, a file store, a web server, a gateway server, an application program, a messaging application, a collaboration application, a calendar application, a print server, and virtually any other type of computing resource provided. Nevertheless, it will be appreciated that a single resource may be provided by both individual and multiple computing devices. Conversely, in other instances, multiple computing resources may be provided by a single computing device, as well as multiple computing devices. As described below, an exemplary computing device 700 is further illustrated and described with respect to FIG. 7.

With continued reference to FIG. 1, the data reporting environment 100 may include a data source layer 102. The data reporting environment 100 may also include a resource reporting application 104 that further comprises a database layer 106, a presentation layer 108, a metrics engine 110, and a data import executable 112.

The data source layer 102 may include databases that provide data regarding the availability of computing resources. For example, the data source layer 102 may include a database 114 configured to store data from an operations manager server application. The operations manager server application may enable the monitoring of numerous computer resources interconnected by one or more communication networks.

In one embodiment, the operations manager server application may include a MICROSOFT OPERATIONS MANAGER® (MOM) server monitoring and management application from Microsoft Corporation of Redmond, Wash. Specifically, the MOM application is known as the event and performance management component of Microsoft's WINDOWS SERVER. For example, the MOM application may monitor computer software applications from the Microsoft Corporation of Redmond, Wash., such as WINDOWS ACTIVE DIRECTORY (AD), WINDOWS INTERNET INFORMATION SERVICE (IIS), MICROSOFT EXCHANGE SERVER, and MICROSOFT SQL SERVER. Accordingly, the MOM application database, which may be database 114, may store computing resource events and availability alerts observed by the MOM application.

In another example, the data source layer 102 may also include a MICROSOFT SYSTEM MANAGEMENT SERVER (SMS) transaction database 116. The SMS application is a systems management product from Microsoft Corporation of Redmond, Wash. Specifically, SMS may provide remote control, software distribution, and software and hardware inventory functions.

In various embodiments, the SMS transaction database 116 may store SMS application events related to the availability of computer resources. However, it will be appreciated that the data source layer 102 may include additional databases 118. These additional databases 118 may store computer resource monitoring and alert data from other monitoring applications. Accordingly, the foregoing list of exemplary databases is not intended to limit any claimed subject matter.

As described above, the data in the databases 114-118 may include computing resource events and alerts. For example, if the computing resource is an e-mail server, the computing resource events and alerts may include the times of start and stop events for the e-mail server. Stop events may indicate that the e-mail server has stopped providing services to e-mail clients. Likewise, start events may signify that that the e-mail server has resumed providing services to the e-mail clients. In another example, if the computing resource is a web server, the computing resource events and alerts may include the times that the web server stopped responding to web page requests, e.g., stop events, as well as the times the web server resumed its response to web page requests, e.g., start events.

Nevertheless, it will be appreciated that computing resource events and alerts may include a variety of other events that are related to the availability or performance of computing resources. For example, returning to the instance of an e-mail server, computing resource events may further include e-mails received, e-mail recipients blocked, e-mail sender blocked, attachments purged, and the like.

The database layer 106 enables the application of schema semantics to the database records stored in the databases in the data source layer 102. In other words, the database layer 106 may facilitate the organization and aggregation of the database records from the data source layer 102. The database layer 106 may include a staging database 120 and a data warehouse 122. In turn, the data warehouse 122 may further include one or more data “cubes” 124.

The staging database 120 may receive data from databases 114-118 of the data source layer 102 via a first data transformation service (DTS) 126. Additionally, the data warehouse 122 may receive transformed data from the staging database 120 via a second DTS 128. Likewise, the data from data warehouse 122 may be rearranged into one or more data “cubes” 124 via a third DTS 130. It will be appreciated that according to various embodiments, DTS 126-130 are generally sets of objects and utilities that are configured to perform automated retrieval of data, as well as the transformation and loading of data, respectively from and into databases. In some embodiments, DTS 126-130 may be configured to periodically collect and transfer data from a first database to a second database. For example, DTS 126 may be configured to move data records from the database 114 to the staging database 120 once per day at midnight. In other embodiments, DTS 126-130 may be configured to move and transform data. For example, a column of data in a data record set may be moved to a different column. In another example, a column of data in a data record set may be reformatted from a text string to a date.

The metrics engine 110 may perform availability calculations on the data in the staging database 120. These availability calculations may provide useful metrics, that is, quantitative measurements of computing resource availability.

For example, in the instance of the e-mail server described above, the metrics engine 110 may be configured to calculate total outage duration and availability duration. In such an example, the metrics engine 110 may first identify the times of start and stop events. Second, the metrics engine 110 may calculate total outage duration as the time difference between the occurrence of each stop event and the corresponding start events. Moreover, the metrics engine 110 may also calculate total availability duration as the difference between the total operation time of the e-mail server and the outage time.

Additionally, in another example with respect to the e-mail server, the metrics engine 110 may also calculate metrics such as the total number of e-mails received in a given period (e.g., per day, per week, etc.), the total number of e-mail recipients blocked in a given period, the total number of attachments purged in a given period, and the like. Moreover, it will be appreciated that the metrics engine 110 may execute the availability calculations at regular time intervals, such as once per day, once per week, etc.

The data warehouse 122 may be configured to organize and aggregate the availability results, as calculated by the metrics engine 110, from the staging database 120. In one implementation, the second DTS 128 may periodically copy the availability calculation results from the staging database 120 to the data warehouse 122. Moreover, the third DTS 130 may then be used to transform, that is, organize and aggregate the availability results.

Specifically, once the availability results arrive in the data warehouse 122, the results may be organized and aggregated according to various schemes. For instance, the results may be organized according to individual computing resource. Accordingly, availability result for a specific computing resource may include the resource name, resource role, date, outage duration, and calculated availability duration. In another instance, the availability results for resources having the same role may be combined and averaged to provide availability figures for all of the resources sharing the same role. For example, in a scenario where the metric engine 110 has calculated availability results for a plurality of e-mail servers, the third DTS 130 may combine the availability results for all of the e-mail servers to compute total availability figures (e.g., total outage duration, total availability duration, total number of e-mail recipients blocked, total number of attachments purged, and the like).

Furthermore, it will be appreciated that other more complex data organizational schemes may be implemented on the availability results in data warehouse 122. For instance, the availability results may be organized using one or more data “cubes” 124. In the “cube” database 124, data may be organized according to “dimensions” and hierarchy. For example, availability results for a plurality of e-mail servers may be organized according to “dimensions” such as locations of e-mail servers, time of service outage, cause of outage, type of attachment purged, and the like. In addition, each dimension may be organized using hierarchy. For example, service outage in a given month may be incorporated into a specific quarter, and service outages in the specific quarter may be incorporated into a particular year. In this way, the data “cubes” may enable data to be aggregated in a manner that facilitates efficient data retrieval.

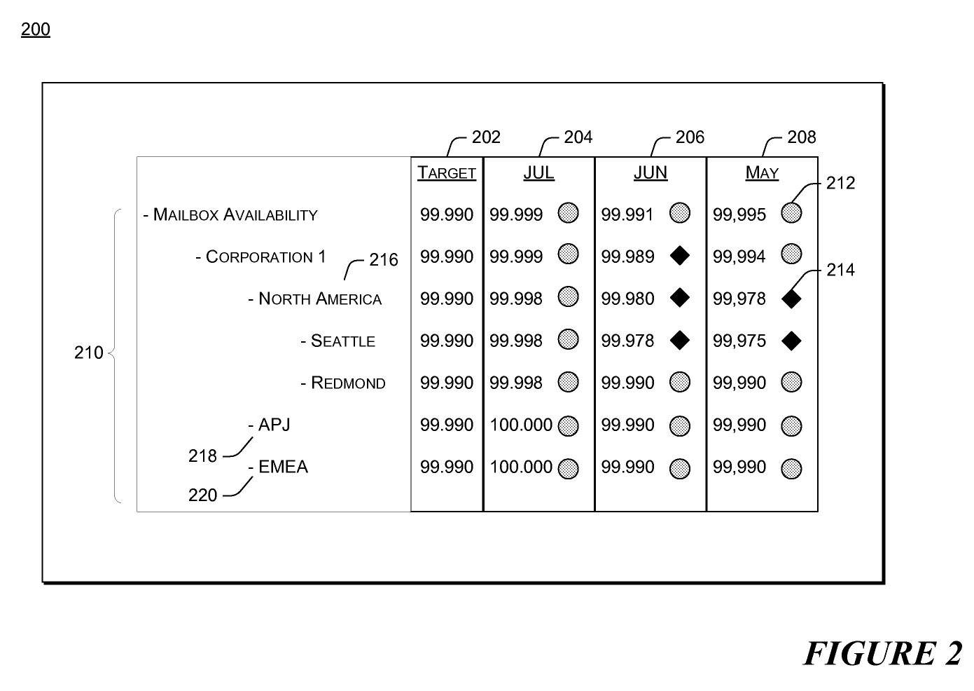

With continued reference to FIG. 1, the presentation layer 108 of the resource reporting application 104 may include a display engine 132 and a presentation interface 134. In one implementation, the presentation interface 134 may include a web site configured to display one or more dynamically generated web pages. Additionally, the display engine 132 may be configured to retrieve the availability results, or metrics, for display on presentation interface 134. According to various instances, the display engine 132 may be configured to provide metric reports that include numerical and graphical representation of calculated resource availability. For example, as show in FIG. 2, the display engine 132 may generated an exemplary metric report that shows the availability of a mailbox on one or more e-mail servers.

As shown in FIG. 2, the exemplary metric report 200 for the mailbox includes a target availability percentage column 202, an actual availability percentage column 204 for the month of July, an actual availability percentage column 206 for the month of June, and an actual availability percentage column 208 for the month of May. In addition, the exemplary metric report 200 also includes rows, as illustrated in area 210, which provide the geographical regions serviced by the e-mail servers. Additionally, first symbols 212 may indicate availability measurements that reached the target percentage. Moreover, availability measurement that did not reach their target percentages may be signified by second symbols 214. In this way, the exemplary metric report 200 may provide metrics, or quantitative measurements, regarding the availability of computing resources.

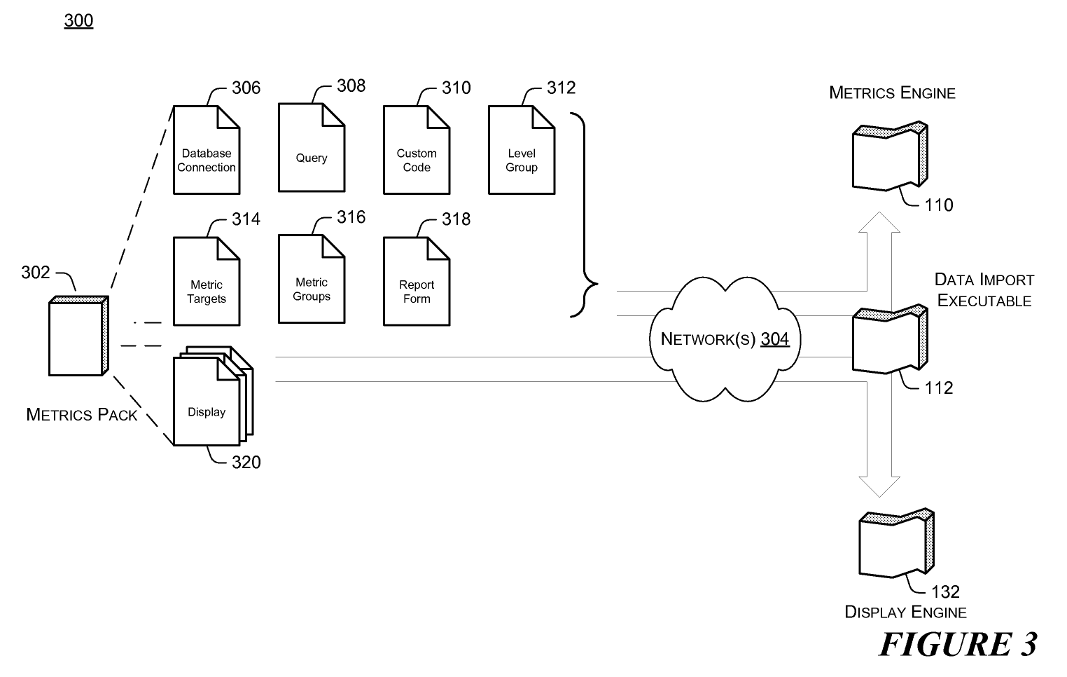

Returning to FIG. 1, as described above, the resource reporting application 104 may also include a data import executable 112. The data import executable 112 may be configured to implement a “metric pack” into the resource reporting application 104. Additional details regarding the data import executable 112 and the “metric pack” are provided below in FIG. 3.

FIG. 3 illustrates a “metric pack” distribution process 300 for providing configuration files to an exemplary resource reporting application shown in FIG. 1. As shown in FIG. 3, a metric pack 302 may be deployed by a data import executable 112 into a metrics engine 110 and a display engine 132 (as described in FIG. 1) via one or more networks 304. The one or more networks 304 may include at least one of a wide-area network (WAN), a local area network (LAN), and the like.

In one implementation, the metric pack 302 may include a plurality of configuration files 306-320. Accordingly, the metrics engine 110 may be configured to calculate computing resource availability using some of the configuration files 306-320. Likewise, the display engine 132 may have the ability to use some of the configuration files 306-322 to format and display the calculated availability results. In various embodiments, the metric pack 302 may be a compressed data distribution file created from the configuration files 306-322. In specific embodiments, the metric pack 302 may be a “cabinet” file, that is, a compressed data distribution file having a format denoted by a “.cab” extension.

Thus, the data import executable 112, or a software component associated with the data import executable 112, may be configured to decompress the compressed data distribution files, such as configuration files 306-322. Moreover, the data import executable 112 may be further configured to implement some of the compressed data distribution files, such as configuration files 306-322, into the metrics engine 110, and some of the configuration files 306-322 into the display engine 132. For example, the data import executable 112 may transform the configure files 306-322 into a format accessible to the metrics engine 110 and display engine 132, and store the files into a block of computer-readable memory accessed by the respective engines.

Moreover, in some embodiments, the configuration files 306-322 may include Extensible Markup Language (XML) files. However, it will be appreciated that in additional embodiments, the configurations 306-322 may include other mark up language files, as well as other non-executable data files. In particular embodiments, the “metric pack” 302 may include a “data connection” file 306, a “query” file 308, a “custom code” file 310, a “level group” file 312, a “metric targets” file 314, a “metric groups” file 316, a “report form” file 318, and one or more “display” file 320. The data import executable 112 may implement these files for use by the metrics engine 110.

Specifically, the “database connection” file 306 may include information that defines data sources. For example, the “database connection” file may define the connection paths and connection protocols to a server management application database 114 (as described in FIG. 1). In one implementation, the “database connection” file may contain connection paths and connection protocols for connecting to a Structured Query Language (SQL) server. In this way, the “database connection” file 306 may dynamically configure the staging database 120 to obtain resource availability data from various data sources. In one embodiment, the “database connection” file 306 may enable the staging database 120 of the database layer 106 to connect to databases 114-118 of the data source layer 102.

The “query” file 308 may include database queries that enable a database to extract information from a data source. Accordingly to various embodiments, the database queries may be SQL queries. In one particular embodiment, the “query” file 308 may include queries that enable a staging database 120 to extract data from databases 114-118.

The “custom code” file 310 may include specialized mathematical functions that are necessary for performing calculations. For example, in the instance where resource availability data may be collection from a plurality of e-mail servers, the specialized functions may enable the calculations of weighted average of mailbox size. Accordingly, in one embodiment, the “custom code” file 310 may include custom created functions that are not part of the SQL function library. It will be appreciated the in other embodiments, the “custom code” file 310 may include additional custom functions that are written to perform specialized functions that are not standard to a database software. Accordingly, the “custom code” file 310 may enable the metrics engine 110 to provide metrics that make use of custom calculation algorithms.

The “level group” file 312 may include information that defines the hierarchy of any metric that includes different levels. For example, returning to FIG. 2, the “level group” file 312 may define sublevels for the metrics showing the availability of the mailbox. For example, the “level group” file 312 may define sublevels such the percentage availability in North America 216, the percentage availability in Asia Pacific Japan (APJ) 218, and the percentage availability in Europe, Middle East and Africa (EMEA) 220. Accordingly, it will be appreciated that the “level group” file 410 may customize the metrics engine 110 to calculate and provide metrics that includes a plurality of levels, or branches. In this way, the metrics engine 110 may provide metrics of different specificity and detail. In addition, the “level group” file 312 may list the computing devices (e.g., one or more e-mail servers that host the mailbox) for which availability data are to be obtained to generate the metrics.

The “metric targets” file 314 may include information that regarding the desirable resource availability for one or more computing resources. For example, the “metric target” file 314 may include the desired availability of an e-mail mailbox in terms of time percentage, such as 98% in a given month. The “metric targets” file 314 may enable the metrics engine 110 to determine whether particular metrics indicate desired objective have been met.

The “metric group” file 316 may include information that lists one or more metrics measurement criteria corresponding to each metric (e.g., amount of time the computing resource is available during a specific period, percentage of time the computing resource is unavailable during the period, etc). The “metric group” file 316 may also include trend types, display label names, tool tip texts, and other data necessary to the one or more metric measurement criteria. Moreover, the “metric group” file 316 may also include lists of mathematical or statistical calculations, that is, the logic algorithms, necessary for obtaining each metric measurement.

For example, for a metric that measures the time necessary to resolve a problem with an e-mail mailbox, the “metric group” file 316 may list all the mathematical functions that are necessary to calculate the time to resolve the problem. In one instance, the time to resolve the problem may in calculated based on how much time one or more e-mail servers were unavailable. The “metric group” file 316 may also include logic algorithms that compare the current time needed to resolve a problem with historical data, as well as identify whether a decrease or increase in time in comparison with the historical data is desirable.

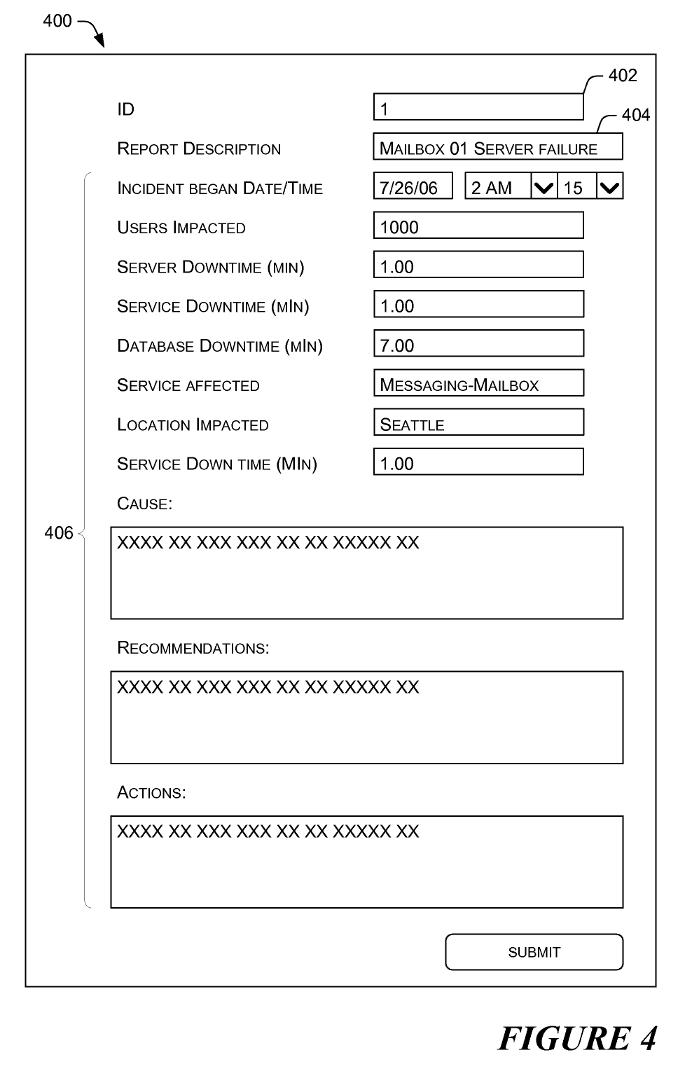

The “report form” file 318 may include configuration data necessary for the metrics engine 110 to create one or more report forms. The report forms may be used to report activities that are relevant to the availability of one or more computing resources. An exemplary report form according to one implementation is illustrated in FIG. 4.

As shown in FIG. 4, the generated report form 400 may be used to report information associated with computing resource failure. In one implementation, once the metrics engine 110 creates the report from 400, the report form 400 may be displayed by the display engine 132 on the presentation interface 134.

For example, report form 400 may include an identification text box 402 that indicates the report number, and a report description textbox 404 that enables a user to input a description of the problem that caused the computing resource failure. Furthermore, report form 400 may enable the user to enter additional types of relevant information into various textboxes located in area 406. In other words, the “report form” file 318 includes information that determines layout and types of information requested by one or more report forms, such as report form 400.

The “display” files 320 may include configuration data that are employed by the display engine 132 to present the metrics calculated by metrics engine 110. In one implementation, the metrics are displayed by the display engine 132 on presentation interface 134. According to various embodiments, each of the files in “display” files 320 determines the configuration of a particular presentation layout displayed on the presentation interface 134, such as the exemplary metric report 200 illustrated in FIG. 2.

Returning to FIG. 2, a particular “display” file included in “display” files 320 may include data that determines the time period for which a metric is shown, e.g., the presentation of availability for the months of “May” 208, “June” 206, and “July” 204. Moreover, the particular display file included in “display” files 320 may also dictate the order of the metric measurements to be presented,

The particular display included in “display” files 320 may also be configured to reference the “level group” file 312 to obtain the order that sublevel metrics may be nested. For example, the particular display file may reference the “level group” file 312 to dictate the nesting of the region titles “North America”, “APJ”, and “EMEA” under “Corporation 1”, as well as the nesting of city titles “Seattle” and “Redmond” under the region title “North America”, as shown in area 210 of FIG. 2.

Additionally, the particular display file included in “display” files 320 may also dictate the formatting of any numerical values, e.g., the placement of commas, decimals, and percentage symbols, and the like. Further, the file may also format graphical comparisons between the availability of the computing resource and corresponding availability target. For instance, as shown in exemplary metric report 200 of FIG. 2, the file may dictate that availabilities that meet or exceed their targets are indicated with a first symbol 212, and availabilities that do not meet their targets are indicated with a second symbol 214. However, it will be appreciated the various files in “display” file 418 may dictate the display of metrics, via other representation, e.g. bar charts, pie charts, Gantt charts, and the like. Moreover, the various files in “display” file 418 may be further configured to reference the “metric target” file 314 and the “metric group” file 316 for data that setup comparison displays of metric availability to targets.

Moreover, while some of the exemplary presentation layouts, as dictated by the “display” files 320, have been discussed with respect to FIG. 2, the “display” files 320 may dictate the format of any presentation displayed by the display engine 132, including the report form 400 discussed in FIG. 4.

It will be further appreciated that in additional embodiments, the metric pack 302 may contain additional data files that are developed for use by metrics engine 110 and display engine 132. In these embodiments, these additional files may also dictate the computation and presentation of computing resource availability.

Finally, while the data reporting environment 100 is described above within the context of collecting and reporting computing resource availability, it will be appreciated that the data reporting environment 100 may also be an application, that is, a reporting platform, which collects and reports other data. For example, in one implementation, the data reporting environment 100 may be an application that provides performance metrics, e.g., rate of advancement on projects and progress towards production or service performance quotas. Accordingly, it will be readily appreciated that the various files described in metric pack 302 may be configured to include data for the collection, analysis and display of performance metrics.

### Exemplary Processes

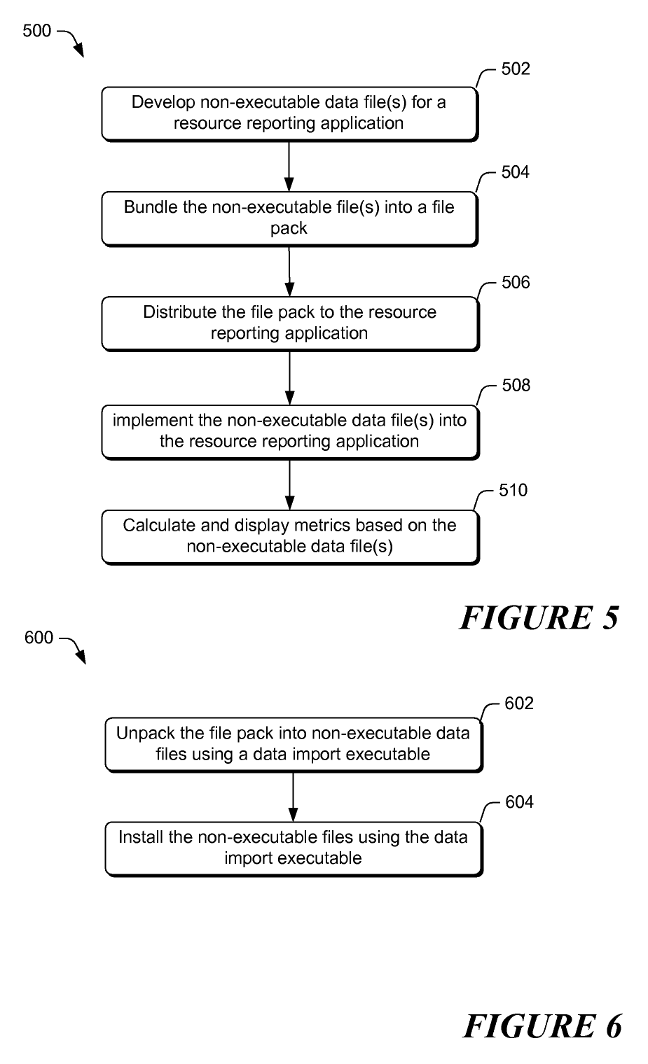

FIGS. 5-6 illustrate exemplary processes of implementing non-executable configuration files into a resource reporting application, as shown in FIG. 1. The exemplary processes in FIGS. 5-6 are illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to the data reporting environment 100 of FIG. 1, although they may be implemented in other system architectures.

FIG. 5 shows a process 500 for providing “metric pack” to the exemplary resource reporting application shown in FIG. 1. At block 502, a programmer may develop one or more non-executable data files. As described above, the one or more non-executable may includes configuration data for the computation and presentation of computing resource availability. In one embodiment, the non-executable data files include the configuration files 306-320 described in FIG. 3. However, it will be appreciated that in other embodiments, the non-executable data files may include other configuration files (e.g., configuration files developed by third-party vendors).

At block 504, the non-executable configuration files are bundled into a file pack. According to various embodiments, the file pack may include the metric pack 302 as described in FIG. 3. The metric pack may be a .cab file created from configuration files 306-320. At block 506, the file pack may be distributed to one or more resource reporting applications, such as resource reporting application 104, via one or more networks 304. For example, the file pack may be distributed via e-mail, (file transfer protocol) FTP file distribution, (Hypertext Transfer Protocol) HTTP file distribution, and the like. According to various implementations, the file pack may be distributed to the one or more resource reporting applications on demand (e.g., user request), on a periodic basis (e.g., as part of a service subscription), or on a need basis (e.g., as a patch or fix).

At block 508, the file pack is implemented into the resource reporting application, such as the resource reporting application 104 described in FIG. 1. At block 510, the resource reporting application 104 may use the non-executable configuration files in the file pack to calculate and display metrics.

FIG. 6 shows an exemplary process 600 for implementing the “metric pack” into the exemplary resource reporting application. Process 600 further illustrates block 508 of exemplary process 500, as shown in FIG. 5.

At block 602, the data import executable 112 may unpack the file pack. According to the various embodiments, the file pack may be a .cab compressed data distribution file. In some embodiments, the file pack may include non-executable configuration files, such as configuration files 306-320. Specifically, the non-executable data file may be in XML format. Subsequently, at block 604, the data import executable 112 may install the non-executable configuration files 306-320 into the resource reporting application 104. In one embodiment, the configuration files 306-320 are specifically installed into a block of computer-readable memory accessible by the metric engine 110. In this way, the non-executable configuration files may be used by the metrics engine 110 and the display engine 132 to acquire computing resource availability data, and calculate and display resource availability.

### Exemplary Computing Environment

FIG. 7 is a block diagram illustrating a representative computing environment 700. In one embodiment, the representative computing environment 700 may be part of a computing device as described in FIG. 1.

Moreover, in other embodiments, the computing environment 700 may be used to host the resource reporting application 104 that includes a data import executable 112. In these embodiments, the representative computing environment may enable the implementation of non-executable configuration files into the resource reporting application 104. However, it will readily appreciate that various embodiments of the resource application 104 may be implemented in different computing environments.

The computing environment 700 shown in FIG. 7 is only one example of a computing environment and is not intended to suggest any limitation as to the scope of use or functionality of the computer and network architectures. Neither should the computing environment 700 be interpreted as having any dependency or requirement relating to any one or combination of components illustrated in the example computing environment.

As depicted in FIG. 7, the exemplary computing environment 700 may include a computing device 702 having one or more processors 706. A system memory 708 is coupled to the processor(s) 706 by one or more buses 710. The one or more buses 710 may be implemented using any kind of bus structure or combination of bus structures, including a memory bus or memory controller, a peripheral bus, an accelerated graphics port, and a processor or local bus using any of a variety of bus architectures. It is appreciated that the one or more buses 710 provide for the transmission of computer-readable instructions, data structures, program modules, and other data encoded in one or more modulated carrier waves. Accordingly, the one or more buses 710 may also be characterized as computer-readable mediums.

The system memory 708 may include both volatile and non-volatile memory, such as random access memory (RAM) 712, and read only memory (ROM) 714. The environment 700 also includes one or more mass storage devices, which may also be characterized as mass storage type input/output devices, may include a variety of types of volatile and non-volatile media, each of which can be removable or non-removable. For example, the mass storage devices may include a hard disk drive 718 for reading from and writing to a non-removable, non-volatile magnetic media, a magnetic disk drive 720 for reading from and writing to a removable, non-volatile magnetic disk 722 (e.g., a “floppy disk”), and an optical disk drive 724 for reading from and/or writing to a removable, non-volatile optical disk 726 such as a compact disk (CD), digital versatile disk (DVD), or other optical media. Although not shown, the one or more mass storage devices may also include other types of computer-readable medium, such as magnetic cassettes or other magnetic storage devices, flash memory cards, electrically erasable programmable read-only memory (EEPROM), or the like. The hard disk drive 718, magnetic disk drive 720, and optical disk drive 724 may each be connected to the system bus 710 by one or more data media interfaces 728. Alternatively, the hard disk drive 718, magnetic disk drive 720, and optical disk drive 724 may be coupled to the system bus 710 by a SCSI interface (not shown), or other coupling mechanism.

In addition to the mass storage type input/output devices described above, the environment 700 includes various input/output devices such as a display device 704, a keyboard 738, a pointing device 740 (e.g., a “mouse”) and one or more communication ports 750. In further embodiments, the input/output devices may also include speakers, microphone, printer, joystick, game pad, satellite dish, scanner, card reading devices, digital or video camera, or the like. The input/output devices may be coupled to the system bus 710 through any kind of input/output interface 742 and bus structures, such as a parallel port, serial port, game port, universal serial bus (USB) port, video adapter 744 or the like.

The computing environment 700 may further include one or more additional computing devices 746 communicatively coupled by one or more networks 748. Accordingly, the computing device 702 may operate in a networked environment using logical connections to one or more remote computing devices 746. The remote computing device 746 can comprise any kind of computer equipment, including personal computers, server computers, hand-held or laptop devices, multiprocessor systems, microprocessor-base systems, set top boxes, game consoles, programmable consumer electronics, network PCs, minicomputers, and mainframe computers. The remote computing devices 746 may include all of the features discussed above with respect to computing device 702, or some subset thereof. The networked environment may further be utilized to implement a distributed computing environment. In a distributed computing environment, computing resources can be physically dispersed throughout the environment.

Any type of network 748 can be used to couple the computing device 702 with one or more remote computing devices 746, such as a wide-area network (WAN), a local area network (LAN), and/or the like. The computing device 702 may be coupled to the network 748 via a communication port 750, such as a network interface card. The communication port 750 may utilize broadband connectivity, modem connectivity, DSL connectivity, or other connection strategy. Although not illustrated, the computing environment 700 may also provide wireless communication functionality for connecting computing device 702 with remote computing devices 746 (e.g., via modulated radio signals, modulated infrared signals, etc.). It is appreciated that the one or more networks 748 provide for the transmission of computer-readable instructions, data structures, program modules, and other data encoded in one or more modulated carrier waves.

Generally, one or more of the above-identified computer readable-mediums provide storage of computer-readable instructions, data structures, program modules, and other data for use by the computing device 702. For instance, one or more of the computer-readable medium may store the operating system 730, one or more application functionalities 732 (including functionality for implementing aspects of the software transformation methods), other program modules 734, and program data 736. More specifically, the ROM 714 typically includes a basic input/output system (BIOS) 716. BIOS 716 contains the basic routines that help to transfer information between elements within computing device 702, such as during start-up. The RAM 712 typically contains the operating system 730′, one or more applications functionalities 732′, other program modules 734′ and program data 736′, in a form that can be quickly accessed by the processor 706. The content in the RAM 712 is typically transferred to and from one or more of the mass storage devices (e.g., hard disk drive 718), for non-volatile storage thereof.

It is appreciated that the illustrated operating environment 700 is only one example of a suitable operating environment and is not intended to suggest any limitation as to the scope of use or functionality of the various embodiments described. Other well-known computing systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The distribution of “metric packs” to resource reporting applications may enable IT professionals to quickly and efficiently update resource reporting applications to calculate new metrics or modified metrics without costly and time consuming custom code development and application modification. For example, the need to reinstall or reboot a resource reporting application as part of the update process may be advantageously eliminated. Moreover, the ability to update resource reporting applications via “metric packs” may enable IT professionals to deploy custom-developed metric configuration files that calculate and display specialized metrics.

### CONCLUSION

In closing, although the various embodiments have been described in language specific to structural features and/or methodological acts, it is to be understood that the subject matter defined in the appended claims is not necessarily limited to the specific features or acts described. Rather, the specific features and acts are disclosed as exemplary forms of implementing the claimed subject matter.

1. A method comprising:
bundling one or more non-executable data files into a file pack, wherein the non-executable data files are configured to be implemented on a resource reporting application;
distributing the file pack to the resource reporting application;
implementing the one or more non-executable data files into the resource reporting application using an executable application.

2. The method of claim 1, further comprising developing one or more non-executable data files, wherein the non-executable data files are configured to be implemented on a resource reporting application.

3. The method of claim 1, wherein implementing the one or more non-executable data files includes implementing the one or more non-executable data files into a metric reporting application.

4. The method of claim 2, wherein developing one or more non-executable data files includes developing at least one of a group comprising a metric calculation definitions file, a metric branching definitions file, a database query definitions file, a metric target definitions file, a report form definitions file, and a metric display configuration definitions file.

5. The method of claim 4, wherein the database query definitions includes Structured Query Language (SQL) query definitions.

6. The method of claim 1, further comprising at least one of calculating and displaying one or more metrics based on the one or more non-executable data files.

7. The method of claim 1, wherein developing one or more non-executable data files includes developing one or more non-executable Extensible Markup Language (XML) data files.

8. The method of claim 1, wherein implementing the one or more non-executable data files includes using an executable application to unpack the file pack and install the non-executable data files into the resource reporting application.

9. The method of claim 1, wherein bundling one or more non-executable data files includes bundling the one or more non-executable data file into a .cab file pack.

10. A computer readable medium having computer-executable instructions that, when executed, perform acts comprising:
receiving a file pack that includes one or more non-executable data files;
unpacking the file pack into the one or more non-executable data files; and
implementing information in the one or more non-executable data files into a metric reporting application using an executable application.

11. The computer readable medium of claim 10, wherein the one or more non-executable data files includes at least one from a group comprising a metric calculation definitions file, a metric branching definitions file, a database query definitions file, a metric target definitions file, a report form definitions file, and metric display configuration definitions file.

12. The computer readable medium of claim 11, wherein the database query definitions file include SQL query definitions.

13. The computer readable medium of claim 10, wherein the one or more non-executable data files are XML files.

14. The computer readable medium of claim 10, wherein the file pack includes a .cab file pack.

15. The computer readable medium of claim 10, wherein unpacking the file pack includes using an executable application to unpack the file pack into one or more non-executable data files.

16. The computer readable medium of claim 15, wherein implementing information includes using an executable application to install the one or more non-executable data files into the metric reporting application.

17. A system, the system comprising:
one or more processors; and
memory allocated for storing a plurality of computer-executable instructions which are executable by the one or more processors, the computer-executable instructions comprising:
instructions for receiving a file pack that includes one or more non-executable data files;
instructions for unpacking the file pack into the one or more non-executable data files;
instructions for implementing information in the one or more non-executable data files into a resource reporting application.

18. The system of claim 17, wherein the file pack includes a .cab file pack.

19. The system of claim 17, wherein the instructions for implementing the one or more non-executable data files includes instructions for unpacking the file pack and installing the non-executable data files into the resource reporting application.

20. The system of claim 19, wherein the one or more non-executable data files are XML files.
